(19) United States
(12) Patent Application Publication
(10) Pub. No.: US 2026/0246565 A1
(43) Pub. Date: Aug. 20, 2026

(54) METHOD FOR DATA TRANSMISSION BETWEEN DEVICES IN COMPUTING SYSTEM, AND COMPUTER-READABLE RECORDING MEDIUM FOR PERFORMING THE SAME

(71) Applicant: RESEARCH & BUSINESS FOUNDATION SUNGKYUNKWAN UNIVERSITY, Suwon-si (KR)

(72) Inventor: Jung Rae KIM, Suwon-si (KR)

(21) Appl. No.: 19/539,740

(22) Filed: Feb. 13, 2026

(30) Foreign Application Priority Data
Feb. 14, 2025 (KR) 10-2025-0019216

(51) Int. Cl. H04L 1/00

(52) U.S. Cl. CPC H04L 1/0057; H04L 1/0045; H04L 1/0047; H04L 1/0061

(57) ABSTRACT

There is provided a method for inter-device data transmission in a computing system where a plurality of computing devices are connected, the method comprising: a first computing device within the computing system performing CRC (cyclic redundancy check) encoding to generate a first checksum for a data payload, and transmitting a flit comprising the data payload and the first checksum to a second computing device within the computing system; and the second computing device generating a second checksum based on the data payload comprised in the flit, and performing CRC decoding comparing the second checksum with the first checksum, wherein the flit is generated by including a sequence number in the CRC encoding and the CRC decoding.

### CROSS-REFERENCE TO RELATED APPLICATION

This application claims the benefit of Korean Patent Application No. 10-2025-0019216, filed on February 14, 2025, in the Korean Intellectual Property Office, the disclosure of which is incorporated herein by reference in its entirety.

### TECHNICAL FIELD

The present disclosure relates to an inter-device data transmission technology in a computing system, and more particularly, to a data transmission technology suitable for detecting lost data during data transmission.

### BACKGROUND OF THE INVENTION

As the rate of performance improvement of individual computing devices gradually slows down, data centers are adopting an extended computing method in which a plurality of computing devices are connected to each other to process large-scale computations. The extended computing method uses a high-speed and high-bandwidth interconnection protocol to connect a plurality of computing devices.

CXL (Compute Express Link) is a technology proposed to meet these needs, capable of supporting high-bandwidth, low-latency, and fine-grained data transmission by addressing the shortcomings of the existing PCIe (Peripheral Component Interconnect Express).

However, while CXL has increased the transmission speed, it has vulnerabilities to errors occurring during the data transmission process. To address these errors and support reliable data transmission, schemes such as CRC (Cyclic Redundancy Check) and FEC (Forward Error Correction) are being adopted.

However, these techniques have a limitation of difficulty in actively addressing the data loss problem in a multi-node environment having a larger number of computing devices connected by switches, for example, in a data transmission environment based on flits (flow control units).

The above-mentioned background art is information held by the inventor for deriving the present disclosure or acquired in the process of deriving the present disclosure, and is not necessarily publicly known art disclosed to the general public before the filing of the present disclosure.

### SUMMARY OF THE INVENTION

An embodiment of the present disclosure provides a data transmission technique for addressing flit loss in a multi-node environment.

An embodiment of the present disclosure provides a data transmission technique capable of providing a reliable multi-node environment by detecting not only data errors occurring during a data transmission process but also errors due to flit loss by including a sequence number of a flit in a CRC encoding and decoding process.

The problems to be solved by the present invention are not limited to those described above, and other problems not explicitly described herein will be clearly understood by a person having ordinary skill in the art to which the present invention pertains from the following descriptions.

In accordance with an aspect of the present disclosure, there is provided a method for inter-device data transmission in a computing system where a plurality of computing devices are connected, the method comprising: a first computing device within the computing system performing CRC (cyclic redundancy check) encoding to generate a first checksum for a data payload, and transmitting a flit comprising the data payload and the first checksum to a second computing device within the computing system; and the second computing device generating a second checksum based on the data payload comprised in the flit, and performing CRC decoding comparing the second checksum with the first checksum, wherein the flit is generated by including a sequence number in the CRC encoding and the CRC decoding.

The computing system further comprises a switching device determining a transmission path for the data payload between the first computing device and the second computing device, and the method further comprises: the switching device performing FEC (Forward Error Correction) decoding based on the flit received from the first computing device to correct an error in the data payload; and the switching device performing FEC encoding to generate redundancy for the data payload, and transmitting the flit comprising the data payload, the first checksum, and the redundancy to the second computing device.

The method further comprising: the second computing device receiving the flit comprising the data payload, the first checksum, and the redundancy from the switching device.

The method further comprises: the second computing device performing FEC decoding based on the flit after receiving the flit from the switching device to correct an error in the data payload; and the second computing device generating the second checksum after performing the FEC decoding, and performing the CRC decoding comparing the second checksum with the first checksum, wherein the CRC decoding comprises checking the sequence number.

The flit comprises: a header area storing one of an ACK (acknowledgement) message, a NACK (negative acknowledgement) message, and the sequence number; a payload area storing the data payload; a CRC area storing the first checksum; and an FEC area storing the redundancy.

The method further comprising detecting, by the second computing device, whether the flit is lost even if the sequence number is not recorded in the header area and only the ACK message or the NACK message is recorded.

The transmitting comprises: the first computing device performing FEC encoding after performing the CRC encoding to generate the redundancy; and transmitting the flit comprising the data payload, the first checksum, and the redundancy to the switching device.

In accordance with an aspect of the present disclosure, there is provided a method for inter-device data transmission in a computing system where a plurality of computing devices are connected, wherein the computing system comprises a switching device determining a transmission path for a data payload between a first computing device and a second computing device, the method comprises: the first computing device performing CRC encoding for the data payload to generate a first checksum; the first computing device performing first FEC encoding to generate redundancy for the data payload; the first computing device transmitting a flit comprising the data payload, the first checksum, and the redundancy to the switching device; the switching device performing first FEC decoding based on the flit to correct an error in the data payload; the switching device performing second FEC encoding to generate the redundancy; the switching device transmitting the flit comprising the data payload, the first checksum, and the redundancy to the second computing device; the second computing device performing second FEC decoding based on the flit received from the switching device to correct an error in the data payload; and the second computing device generating a second checksum based on the data payload comprised in the flit received from the switching device, and performing CRC decoding comparing the second checksum with the first checksum included in the flit, wherein the flit is generated by including a sequence number in the CRC encoding and the CRC decoding.

The flit comprises: a header area storing one of an ACK message, a NACK message, and the sequence number; a payload area storing the data payload; a CRC area storing the first checksum; and an FEC area storing redundancy from the first FEC encoding and the second FEC encoding.

The method further comprising detecting, by the second computing device, whether the flit is lost even if the sequence number is not recorded in the header area and only the ACK message or the NACK message is recorded.

In accordance with an aspect of the present disclosure, there is provided a non-transitory computer-readable recording medium storing a computer program including instructions for causing a processor to perform a data transmission method in a computing system where a plurality of computing devices are connected, the data transmission method comprising: a first computing device within the computing system performing CRC encoding to generate a first checksum for a data payload, and transmitting a flit comprising the data payload and the first checksum to a second computing device; and the second computing device generating a second checksum based on the data payload comprised in the flit, and performing CRC decoding comparing the second checksum with the first checksum, wherein a sequence number is included in the CRC encoding and the CRC decoding.

In accordance with an aspect of the present disclosure, there is provided a computer program stored on a non-transitory computer-readable recording medium including instructions for causing a processor to perform a data transmission method in a computing system where a plurality of computing devices are connected, the data transmission method comprising: a first computing device within the computing system performing CRC encoding to generate a first checksum for a data payload, and transmitting a flit comprising the data payload and the first checksum to a second computing device; and the second computing device generating a second checksum based on the data payload comprised in the flit, and performing CRC decoding comparing the second checksum with the first checksum, wherein a sequence number is included in the CRC encoding and the CRC decoding.

In accordance with an aspect of the present disclosure, there is provided a non-transitory computer-readable recording medium storing a computer program including instructions for causing a processor to perform a data transmission method in a computing system where a plurality of computing devices are connected, wherein the computing system comprises a switching device determining a transmission path for a data payload between a first computing device and a second computing device, the data transmission method comprising: the first computing device performing CRC encoding for the data payload to generate a first checksum; the first computing device performing first FEC encoding to generate redundancy for the data payload; the first computing device transmitting a flit comprising the data payload, the first checksum, and the redundancy to the switching device; the switching device performing first FEC decoding based on the flit to correct an error in the data payload; the switching device performing second FEC encoding to generate the redundancy; the switching device transmitting the flit comprising the data payload, the first checksum, and the redundancy to the second computing device; the second computing device performing second FEC decoding based on the flit received from the switching device to correct an error in the data payload; and the second computing device generating a second checksum based on the data payload comprised in the flit received from the switching device, and performing CRC decoding comparing the second checksum with the first checksum included in the flit, wherein the flit is generated by including a sequence number in the CRC encoding and the CRC decoding.

In accordance with an aspect of the present disclosure, there is provided a computer program stored on a non-transitory computer-readable recording medium including instructions for causing a processor to perform a data transmission method in a computing system where a plurality of computing devices are connected, wherein the computing system comprises a switching device determining a transmission path for a data payload between a first computing device and a second computing device, the data transmission method comprising: the first computing device performing CRC encoding for the data payload to generate a first checksum; the first computing device performing first FEC encoding to generate redundancy for the data payload; the first computing device transmitting a flit comprising the data payload, the first checksum, and the redundancy to the switching device; the switching device performing first FEC decoding based on the flit to correct an error in the data payload; the switching device performing second FEC encoding to generate the redundancy; the switching device transmitting the flit comprising the data payload, the first checksum, and the redundancy to the second computing device; the second computing device performing second FEC decoding based on the flit received from the switching device to correct an error in the data payload; and the second computing device generating a second checksum based on the data payload comprised in the flit received from the switching device, and performing CRC decoding comparing the second checksum with the first checksum included in the flit, wherein the flit is generated by including a sequence number in the CRC encoding and the CRC decoding.

According to an embodiment of the present disclosure, reliable data transmission is enabled by addressing the problem of flit loss in a multi-node environment of a data center. A switching device is utilized to configure a multi-node environment, and a problem occurs in which an entire flit is lost if a data transmission error occurs at the switching device. According to an embodiment of the present disclosure, the problem of flit loss may be addressed by enabling a device receiving data to detect flit loss without additional performance degradation, and flit loss at a CXL switching device may be detected with minimum overhead compared to conventional technology through a new CXL flit structure and a CXL CRC encoding and decoding method. Through this, the present disclosure is expected to enable reliable data transmission without performance degradation in an extended computing environment.

### BRIEF DESCRIPTION OF THE DRAWINGS

FIG. 1 is a diagram illustrating an exemplary structure of a flit required for performing a data transmission method according to an embodiment of the present disclosure.

FIG. 2 is a block diagram illustrating an exemplary computing system for implementing an inter-device data transmission method according to an embodiment of the present disclosure.

FIG. 3 is a timing chart illustrating a data transmission method of a computing system according to an embodiment of the present disclosure.

FIG. 4 is an exemplary diagram of a computing system for explaining the data transmission method of FIG. 3.

FIG. 5 is a timing chart for explaining the data transmission method of FIG. 3 by way of example.

FIG. 6 is a graph comparing experimental results of a computing system in a case where a conventional method is applied and in a case where an inter-device data transmission method according to an embodiment of the present disclosure is applied.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

Hereinafter, embodiments of the present disclosure will be described in detail with reference to the attached drawings.

The industry has used PCIe to connect different devices. However, PCIe is unsuitable for supporting extended computing in data centers because it has the disadvantage of not being able to address the cache coherency problem in a multi-node environment.

CXL emerged to address this problem. CXL may support high-bandwidth, low-latency, and fine-grained data transmission required by devices in a data center by adding and modifying various functions to PCIe technology to address the cache coherency problem among various devices in the data center.

The initial CXL 1.0 was implemented in a peer-to-peer (P2P) manner where devices wishing to transmit data directly exchange data without going through an intermediary device. However, since a switch corresponding to an intermediary device is utilized to connect a large number of computing nodes to each other within a data center, the latest CXL 3.0 supports a switching function. Various computing devices (CPU, GPU, memory, accelerators) are connected to a CXL switch, and this CXL switch serves to facilitate flexible and efficient sharing of computing resources of the computing devices.

Meanwhile, conventional high-speed interconnect protocols used packets as the basic unit of data transmission. A single packet is composed of a variable-length data payload to be transmitted and framing tokens indicating the start and end of the data payload.

However, it is known that such packet-based protocols are not suitable for fine-grained data transmission in a multi-node environment. Accordingly, CXL proposed a new unit called a flit, capable of transmitting only a fixed-size data payload without framing tokens.

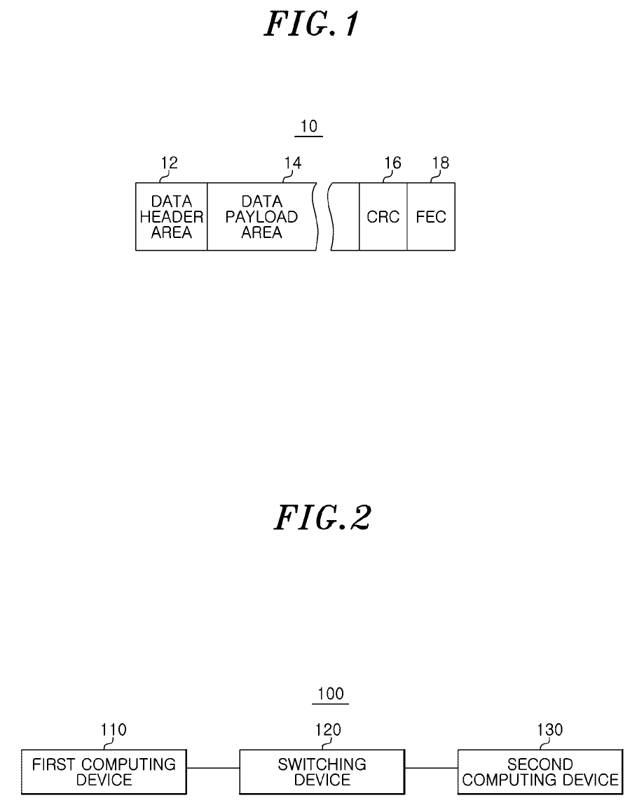

FIG. 1 is a diagram illustrating an exemplary structure of a flit required for performing a data transmission method according to an embodiment of the present disclosure.

The latest specification (spec.), CXL 3.0, provides a 256B (byte) flit, and FIG. 1 illustrates such a 256B flit.

As illustrated in FIG. 1, a flit 10 may include a 2B data header area 12, a 240B fixed-size data payload area 14, an 8B CRC area 16, and a 6B FEC area 18. The 2B data header area 12 indicates the attributes and characteristics of the data. The FEC area 18 and the CRC area 16 serve to protect the entire flit 10 from data transmission errors.

Since devices in a data center exchange a vast amount of data with each other, CXL has evolved over generations in a direction of increasing the data transmission rate. However, to achieve such a high data transmission rate, the reliability of data transmission has been sacrificed. For example, in the case of CXL 3.0, the latest specification of CXL, technologies such as PAM-4 (Four-Level Pulse Amplitude Modulation), a signal modulation technique widely used for high-speed data transmission, and a decision feedback equalizer have been adopted to minimize the associated noise. Although these technologies enable high-speed transmission, they have the disadvantage of making data transmission vulnerable to errors, and such errors even appear as more serious errors, which are long-form burst errors. Such errors in the transmission process may cause flit corruption or permanent flit loss.

### 1. CXL Flit Corruption

The case where a bit error occurs within a flit during the transmission process is referred to as flit corruption. If the receiving side fails to properly detect this corrupted flit and uses it as is, a serious system error may occur. To prevent this situation, CXL introduces a reliability mechanism in which the receiving side detects an error and requests retransmission. The reliability mechanism will be described in detail below.

### 2. CXL Flit Loss

A bit error occurring during the transmission process may cause not only flit corruption but also a more serious problem of flit loss, where an entire flit disappears. If a transmission error is detected at a switch device, under a general flit corruption recovery mechanism, the corresponding flit may be discarded without an error detection and retransmission request being generated. As described above, various computing devices are connected to the switch device, and in this environment, if the switch device detects an error, the switch device determines the entity having forwarded the flit by looking at the data header of the flit and requests retransmission. However, if an error has occurred in this data header, there is a possibility of requesting retransmission from a wrong device, so the flit is discarded without requesting retransmission. Therefore, from the perspective of the endpoint, the final destination of the data, the disappearance of a single flit like this may cause a very serious problem, and CXL also introduces a reliability mechanism for detecting flit loss.

Meanwhile, CXL introduces various reliability mechanisms to address flit corruption and flit loss.

### 1. CRC & ACK/NACK System

CRC is a scheme enabling detection of flit corruption at the data receiving end. A flit transmitting end undergoes an encoding process to generate a checksum from the data to be protected, and transmits this checksum along with the data. A receiving end undergoes a decoding process of generating a checksum based on the received data and comparing the generated checksum with the received checksum.

If a mismatch occurs between the two checksums, it means that an error has occurred during the data transmission process. Therefore, the receiving end transmits a NACK (Negative Acknowledgement) message to the transmitting end to request flit retransmission, and if no mismatch occurs, it transmits an ACK (Acknowledgement) message signifying that the data has been properly received.

### 2. FEC

Error detection and retransmission request using CRC is robust, but it has the disadvantage that it may cause excessive retransmissions if errors occur frequently. To prevent this, the CXL 256B flit provides an FEC function in addition to CRC. A transmitting side undergoes an encoding process to generate redundancy based on the data to be protected, and transmits this redundancy along with the data. A receiving end undergoes an FEC process to correct an error once using the received data and redundancy before performing CRC, which has the effect of reducing the probability of CRC requesting a retransmission and preventing excessive retransmissions.

### 3. Sequence Number

Although CRC and FEC are powerful, they have the disadvantage of being applicable only to a received flit, and therefore are unable to address flit loss involving the disappearance of an entire flit. To overcome this, the header of the 256B flit includes a sequence number field. A transmitting side records which sequence number the corresponding flit has in this sequence number field, and a final receiving side may detect flit loss by checking this field. For example, if the transmitting side records 0, 1, and 2 respectively in the sequence number field and transmits three flits in order, but flit number 1 is lost at the switch device, the receiving side will receive flit number 2 after flit number 0, so it may detect the flit loss undetectable by CRC and FEC.

However, this sequence number field does not always contain the flit sequence number. As described above, the data receiving part informs the transmitting part whether it has received the data well or not with an ACK/NACK message. To improve performance degradation caused by ACK/NACK messages, CXL allowed an ACK piggybacking feature, which enables writing an ACK number instead of a flit sequence number in the sequence number field. Whether the number written in this field is an ACK, NACK, or sequence number may be indicated through another 2-bit Replay cmd field in the header.

Although this characteristic may alleviate the performance degradation due to ACK/NACK, it may be vulnerable to flit loss. For example, if the first flit is lost but the second flit has an ACK number instead of a sequence number, the receiving side determines that there is no problem because it has received an ACK flit after the first flit, and then the third flit.

In a conventional CXL switch device, after performing FEC and CRC decoding of a flit, if there is an error, the switch discards the flit (flit loss), and if there is no error, it performs CRC and FEC encoding again and forwards the flit to a device. The device receiving the flit performs FEC and CRC decoding, and in addition, if the header field of the flit has a sequence number instead of an ACK message, it also checks the sequence number. This may cause performance degradation in the data transmission process.

Accordingly, an embodiment of the present disclosure is to provide a data transmission technique for providing a reliable multi-node environment by detecting not only data errors occurring during a data transmission process but also errors due to flit loss by including a sequence number of a flit in a CRC encoding and decoding process.

Hereinafter, embodiments of the present disclosure will be described in detail with reference to the accompanying drawings.

FIG. 2 is a block diagram illustrating an exemplary computing system 100 for implementing an inter-device data transmission method according to an embodiment of the present disclosure.

In an embodiment of the present disclosure, the computing system 100 is an electronic device possessed by a user in a computing environment. In an embodiment of the present disclosure, the electronic device may include at least one of an e-book reader, a tablet personal computer, a laptop personal computer, a netbook computer, a desktop computer, and a server computer. In another embodiment, the electronic device may include at least one of network security equipment, navigation equipment, marine electronic equipment, avionics, a vehicle head unit, a point of sales (POS) in a store, and an internet of things device. Furthermore, the electronic device may be equipped with an application for executing various operations (computation operations, transmission/reception operations, error verification operations, etc.) for transmitting data in a computing environment. The application may include, for example, a personal computer (PC) application, a set-top box (STB) application, a web application, an instant application, etc., and is not limited to a specific application.

As illustrated in FIG. 2, the computing system 100 for implementing an inter-device data transmission method may include a first computing device 110, a switching device 120, and a second computing device 130.

The first computing device 110 may include a host transmitting a flit 10 containing a data payload 14 or a device receiving the flit 10.

The second computing device 130 may also include a host transmitting the flit 10 or a device receiving the flit 10, similar to the first computing device 110.

In an embodiment of the present disclosure, for convenience of explanation, the first computing device 110 will be described as a host, and the second computing device 130 will be described as a device. Here, the host may include, for example, a microprocessor-based central processing unit, and the device may include, for example, a graphic processing unit (GPU), a memory, an accelerator, etc.

The switching device 120 may determine a transmission path for the data payload between the first computing device 110 and the second computing device 130. A switching device 120, which corresponds to an intermediary device, is required to connect a large number of computing nodes to each other within a data center, and the latest CXL 3.0 supports a switching function. The first computing device 110 and the second computing device 130 are connected to the switching device 120, and the switching device 120 serves to facilitate flexible and efficient sharing of the resources of these computing devices 110 and 130.

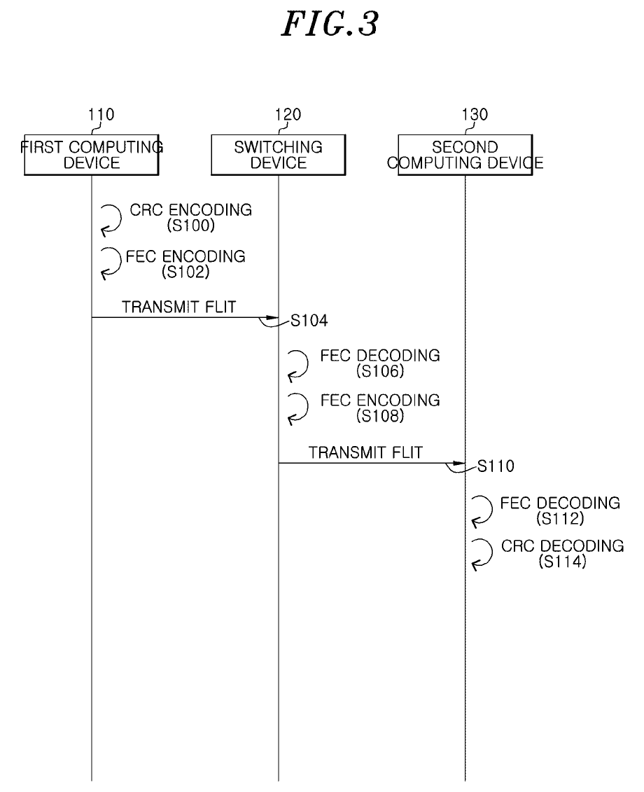

FIG. 3 is a timing chart illustrating a data transmission method of the computing system 100 according to an embodiment of the present disclosure.

As illustrated in FIG. 3, a data transmission method of a computing system 100 including a switching device 120 determining a transmission path for a data payload between a first computing device 110 and a second computing device 130 is disclosed.

First, the first computing device 110 may perform CRC encoding to generate a checksum for the data payload 14 (S100). At this time, in an embodiment of the present disclosure, a sequence number of the flit 10 may be included in the process of performing the CRC encoding, and through this, a flit 10 in which the sequence number is included in the CRC encoding information 16 may be generated.

Thereafter, the first computing device 110 may perform first FEC encoding to generate redundancy for the data payload 14 (S102).

After undergoing such a process, the first computing device 110 may transmit the flit 10 including the data payload 14, the checksum 16 from the CRC encoding, and the redundancy 18 from the first FEC encoding to the switching device 120 (S104).

The switching device 120, having received the flit 10 from the first computing device 110, may perform first FEC decoding based on the received flit 10 to correct an error in the data payload 14 (S106).

When the first FEC decoding is completed, the switching device 120 may perform second FEC encoding to generate redundancy for the data payload of the flit 10 (S108).

When such second FEC encoding is completed, the switching device 120 may transmit the flit 10 including the data payload 14, the checksum 16 from the CRC encoding, and the redundancy 18 from the second FEC encoding to the second computing device 130 (S110).

The second computing device 130, having received the flit 10 from the switching device 120, may perform second FEC decoding based on the received flit 10 to correct an error in the data payload 14 (S112).

Thereafter, the second computing device 130 may generate a checksum based on the data payload 14 included in the flit 10 received from the switching device 120, and perform CRC decoding that compares the generated checksum with the checksum included in the flit received from the switching device 120 (S114). At this time, in an embodiment of the present disclosure, the sequence number of the flit 10 may be checked in the process of performing the CRC decoding, and through this, the second computing device 130 may detect whether the flit 10 has been lost.

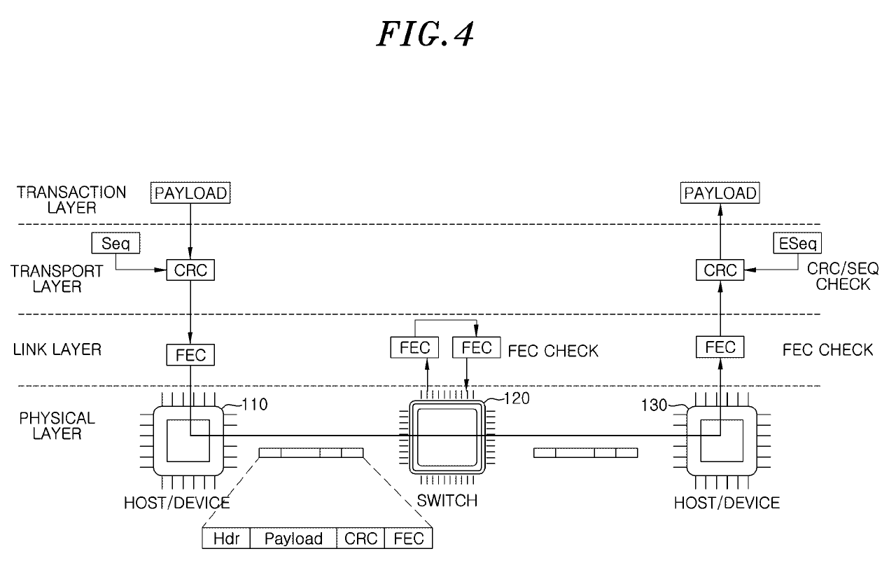

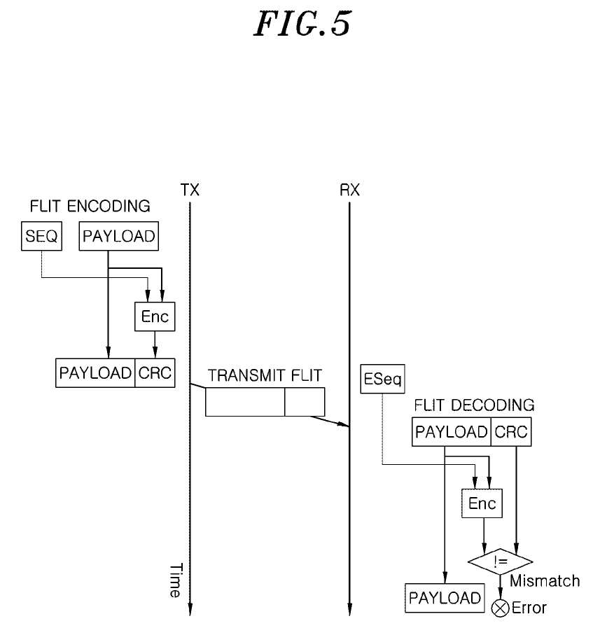

FIG. 4 is an exemplary diagram of the computing system 100 for explaining the data transmission method of FIG. 3.

In a conventional switching device, after performing FEC decoding and CRC decoding of a flit, if there is an error, the flit is discarded (flit loss), and if there is no error, it undergoes a process of performing CRC encoding and FEC encoding again to forward the flit to a device. The device receiving the flit performs FEC decoding and CRC decoding, and in addition, if the header field of the flit has a sequence number instead of an ACK message, it also checks the sequence number.

On the other hand, in the data transmission method according to an embodiment of the present disclosure, CRC encoding and CRC decoding are not performed at the switching device 120, but are performed only at the device transmitting or receiving the flit 10, that is, the first computing device 110 or the second computing device 130. At this time, it is characterized in that the sequence number is included in the CRC encoding and CRC decoding. Since the sequence number is included in the process of CRC encoding and CRC decoding, even if a loss of the flit 10 occurs at the switching device 120 and the flit 10 includes an ACK message instead of a sequence number, the receiving host or device may detect the flit loss and request retransmission of the message to the counterpart.

FIG. 5 is a timing chart for explaining the data transmission method of FIG. 3 by way of example.

In the conventional method, if the sequence number of a flit 10 is inserted into the flit 10 and transmitted, the receiving end may detect flit loss by comparing whether the sequence number of the flit 10 is the correct number. Flit corruption is addressed using CRC. If the transmitting end generates a CRC from the payload and includes it in the flit for transmission, the receiving end may check for errors by determining whether a mismatch occurs by comparing the received CRC with a CRC generated from the payload.

On the other hand, in an embodiment of the present disclosure, the sequence number may be included in the process of encoding the CRC, without being directly inserted into the flit 10.

Thereafter, the receiving end may proceed with decoding by including the sequence number in the process of generating the CRC.

If the sequence number is not the correct number, a mismatch will occur between the received CRC and the generated CRC, so flit loss may be detected.

Through this, the present disclosure enables detection of flit loss without directly transmitting the sequence number.

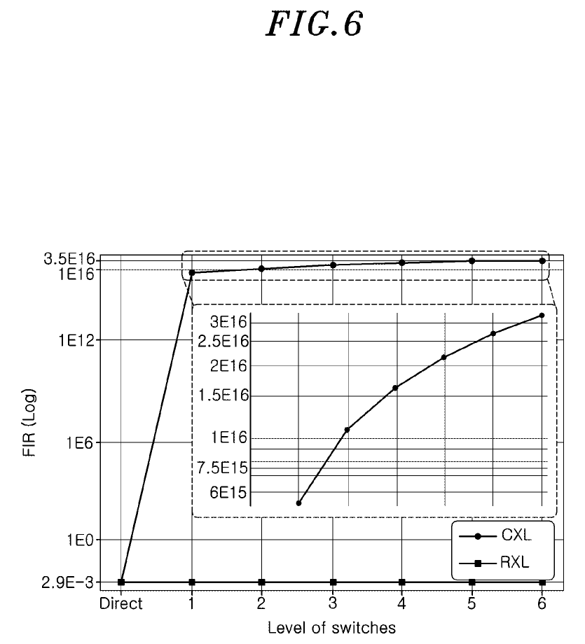

FIG. 6 is a graph comparing experimental results of a computing system in a case where a conventional method is applied and in a case where an inter-device data transmission method according to an embodiment of the present disclosure is applied.

FIG. 6 shows the FIT (Failure in Time) according to the number of switches in the interconnect topology.

In the case where the conventional data transmission method (CXL) is applied, it shows a relatively low FIT such as 2.9E-3 in a direct P2P connection, but it may be seen that if a switch is added, the FIT increases sharply due to flit loss.

On the other hand, if the data transmission method (RXL) according to an embodiment of the present disclosure is applied, it may be confirmed that an increase in FIT due to flit loss does not occur even if a switch is added, and the same level of FIT as a direct P2P connection is maintained.

According to the embodiments of the present disclosure as described above, reliable data transmission is enabled by addressing the problem of flit loss in a multi-node environment of a data center. A switching device is necessary to configure a multi-node environment, and a problem occurs in which an entire flit is lost if a data transmission error occurs at the switch. According to an embodiment of the present disclosure, the problem of flit loss may be addressed by enabling a device receiving data to detect flit loss without additional performance degradation, and flit loss at a CXL switching device may be detected with minimum overhead compared to conventional technology through a new CXL flit structure and a CXL CRC encoding and decoding method. Through this, the present disclosure is expected to enable reliable data transmission without performance degradation in an extended computing environment.

Meanwhile, the combinations of each block in the attached block diagrams and each operation in the flowcharts may also be performed by computer program instructions. These computer program instructions may be loaded onto a processor of a general-purpose computer, a special-purpose computer, or other programmable data processing equipment, so that the instructions, performed through the processor of the computer or other programmable data processing equipment, create means for performing the functions described in each block of the block diagrams.

These computer program instructions may also be stored in a computer-usable or computer-readable recording medium (or memory) for directing a computer or other programmable data processing equipment to implement functions in a specific manner, so that the instructions stored in the computer-usable or computer-readable recording medium (or memory) may also produce an article of manufacture including instruction means for performing the functions described in each block of the block diagrams.

Furthermore, the computer program instructions may also be loaded onto a computer or other programmable data processing equipment, so that a series of operations are performed on the computer or other programmable data processing equipment to generate a computer-executed process, and thus the instructions performing on the computer or other programmable data processing equipment may also provide operations for executing the functions described in each block of the block diagrams.

Furthermore, each block may represent a module, a segment, or a part of a code, which includes at least one or more executable instructions for executing the specified logical function(s). It should also be noted that in some alternative embodiments, the functions mentioned in the blocks may occur out of order. For example, two blocks shown in succession may in fact be performed substantially simultaneously, or the blocks may sometimes be performed in reverse order, depending on the corresponding function.

What is claimed is:

1. A method for inter-device data transmission in a computing system where a plurality of computing devices are connected, the method comprising:
a first computing device within the computing system performing CRC (cyclic redundancy check) encoding to generate a first checksum for a data payload, and transmitting a flit comprising the data payload and the first checksum to a second computing device within the computing system; and
the second computing device generating a second checksum based on the data payload comprised in the flit, and performing CRC decoding comparing the second checksum with the first checksum,
wherein the flit is generated by including a sequence number in the CRC encoding and the CRC decoding.

2. The method of claim 1, wherein
the computing system further comprises a switching device determining a transmission path for the data payload between the first computing device and the second computing device, and
the method further comprises:
the switching device performing FEC (Forward Error Correction) decoding based on the flit received from the first computing device to correct an error in the data payload; and
the switching device performing FEC encoding to generate redundancy for the data payload, and transmitting the flit comprising the data payload, the first checksum, and the redundancy to the second computing device.

3. The method of claim 2, further comprising:
the second computing device receiving the flit comprising the data payload, the first checksum, and the redundancy from the switching device.

4. The method of claim 3, further comprising:
the second computing device performing FEC decoding based on the flit after receiving the flit from the switching device to correct an error in the data payload; and
the second computing device generating the second checksum after performing the FEC decoding, and performing the CRC decoding comparing the second checksum with the first checksum, wherein the CRC decoding comprises checking the sequence number.

5. The method of claim 2, wherein the flit comprises:
a header area storing one of an ACK (acknowledgement) message, a NACK (negative acknowledgement) message, and the sequence number;
a payload area storing the data payload;
a CRC area storing the first checksum; and
an FEC area storing the redundancy.

6. The method of claim 5, further comprising detecting, by the second computing device, whether the flit is lost even if the sequence number is not recorded in the header area and only the ACK message or the NACK message is recorded.

7. The method of claim 2, wherein the transmitting comprises:
the first computing device performing FEC encoding after performing the CRC encoding to generate the redundancy; and
transmitting the flit comprising the data payload, the first checksum, and the redundancy to the switching device.

8. A method for inter-device data transmission in a computing system where a plurality of computing devices are connected, wherein
the computing system comprises a switching device determining a transmission path for a data payload between a first computing device and a second computing device,
the method comprises:
the first computing device performing CRC encoding for the data payload to generate a first checksum;
the first computing device performing first FEC encoding to generate redundancy for the data payload;
the first computing device transmitting a flit comprising the data payload, the first checksum, and the redundancy to the switching device;
the switching device performing first FEC decoding based on the flit to correct an error in the data payload;
the switching device performing second FEC encoding to generate the redundancy;
the switching device transmitting the flit comprising the data payload, the first checksum, and the redundancy to the second computing device;
the second computing device performing second FEC decoding based on the flit received from the switching device to correct an error in the data payload; and
the second computing device generating a second checksum based on the data payload comprised in the flit received from the switching device, and performing CRC decoding comparing the second checksum with the first checksum included in the flit,
wherein the flit is generated by including a sequence number in the CRC encoding and the CRC decoding.

9. The method of claim 8, wherein the flit comprises:
a header area storing one of an ACK message, a NACK message, and the sequence number;
a payload area storing the data payload;
a CRC area storing the first checksum; and
an FEC area storing redundancy from the first FEC encoding and the second FEC encoding.

10. The method of claim 9, further comprising detecting, by the second computing device, whether the flit is lost even if the sequence number is not recorded in the header area and only the ACK message or the NACK message is recorded.

11. A non-transitory computer-readable recording medium storing a computer program including instructions for causing a processor to perform a data transmission method in a computing system where a plurality of computing devices are connected,
the data transmission method comprising:
a first computing device within the computing system performing CRC encoding to generate a first checksum for a data payload, and transmitting a flit comprising the data payload and the first checksum to a second computing device; and
the second computing device generating a second checksum based on the data payload comprised in the flit, and performing CRC decoding comparing the second checksum with the first checksum,
wherein a sequence number is included in the CRC encoding and the CRC decoding.
